(19) United States
(12) Patent Application Publication
(10) Pub. No.: US 2003/0133576 A1
(43) Pub. Date: Jul. 17, 2003

(54) Generation of a common encryption key

(76) Inventor: Frederic Grumiaux, Brussels (BE)

Correspondence Address: Corpotate Patent Counsel, Philips Electronics North America Corporation, 580 White Plains Road, Tarrytown, NY, 10591, US

(21) Appl. No.: 10/149,786

(22) PCT Filed: Oct. 17, 2001
(86) PCT No.: PCT/EP01/12280

(30) Foreign Application Priority Data
Oct. 18, 2000 (EP) 00203592.1

(51) Int. Cl. H04L 9/08

(52) U.S. Cl. 380/279

(57) ABSTRACT

A system for generating a common encryption key for secure communication between devices; the system including:

a plurality of devices, each associated with at least one unique device identifier; the plurality of devices being arranged in subgroups Sᵢ(i=1 . . . n) of devices, with at least one of the subgroups including a plurality of devices; and

a central device including an algorithm generator for generating a key generating algorithm KGA₁ for each of the plurality of devices based on its associated unique device identifier; each of the key generating algorithms KGAᵢ being unique for a respective associated subgroup Sᵢ with the key generating algorithms KGAᵢ being the same for each device of the same subgroup Sᵢ; for each subgroup Sᵢ the associated key generating algorithm KGAᵢ being operative to generate for devices of each subgroup Sⱼ a common subgroup key SGK_{i,j} for use in communication between a device of subgroup Sᵢ and a device of subgroup Sⱼ; the common subgroup key SGK_{i,j} being generated in response to receiving any one of the device identifiers associated with devices in the subgroup Sⱼ;

each device being associated with a respective storage for storing its associated key generating algorithm and including a processor for executing the associated key generating algorithm.

The invention relates to a system, a central device, an end device and respective methods for generating a common encryption key for secure communication between end devices.

Protection of digital audio and/or video content is becoming increasingly important. This includes contents encryption/decryption and access management functions, such as authentication of devices. These functions increasingly rely on crytographic techniques. Such techniques require a same or complementary cryptographic key in the devices that communicate with each other. Particularly, for content protection it is desired that relatively strong encryption keys are used in all countries. Since some countries have legal restrictions on the size of the key so-called key escrow encryption systems (KES) have been developed that enable authorized authorities to recover strong encryption keys where this is a legal requirement. A key escrow system is an encryption system with a backup decryption capability that allows authorised persons (like government officials) to decrypt ciphertext, like encrypted digital content, with the help of information supplied by trusted parties who hold special data recovery keys. The data recovery keys are normally not the same as those used to encrypt and decrypt the data, but rather provide a means of determining the data encryption/decryption keys. The term key escrow is used to refer to the safeguarding of these data recovery keys.

An escrowed encryption system can be divided logically into three main components:

Key Escrow Component (KEC). This component, which is operated by key escrow agents, manages the storage and release or use of data recovery keys. It may be part of a public-key certificate management system or part of a general key management infrastructure. In the remainder, the KEC will also be referred to as central device.

User Security Component (USC). This is a hardware device or software program that provides data encryption and decryption capabilities as well as support for the key escrow function. In the remainder, the USC will usually be referred to as end device or device.

Data Recovery Component (DRC). This consists of the algorithms, protocols, and equipment needed to obtain the plaintext from the ciphertext plus information in the DRC and provided by the KEC. It is active only as needed to perform a specific authorized data recovery.

U.S. Pat. No. 5,016,276 describes the KPS (Key Pre-distribution System) Key Escrow Encryption System. In a basic form of KPS for a network of n devices, the KPS center (or key management center) generates

$$( \begin{matrix}n \\ 2\end{matrix} )$$

secret keys, allocates each secret key to a different pair of devices and securely pre-distributes the secret keys to the devices in the pair. Each device stores n−1different keys. For each device with which it can communicate it uses a different one of those keys. It may, for instance, select that key based on the device ID of the device with which it wants to communicate. In a more complex form, KPS consists of a matrix M and a cryptographic function f. For a network of n devices, the KPS center generates:

$$( \begin{matrix}n \\ 2\end{matrix} )$$

secret keys Kₖₗ, one for each pair of devices k, l.

n unique public keys Kpₖ and pre-distributes one to each device (those public keys may be, for instance, be used as the addresses of the devices in the network).

a matrix M{M_{i,j}} of dimensions n×n having the following property: ƒ(Kpᵢ, Mᵢⱼ)=ƒ(Kpⱼ, Mⱼᵢ)=Kᵢⱼ=Kⱼᵢ. Each column of the matrix is associated with a specific one of the devices. The KPS center pre-distributes to device with ID K the associated column k of the matrix. This column constituting the secret information belonging to the device.

During the initialisation of the communication between the two devices with IDs A and B, each entity sends its public key and its column number (column number a for device A, b for device B) to the other entity. Device A calculates ƒ(Kp_{b}, M_{ba}), device B calculates ƒ(KPₐ, M_{ab}). Both devices obtain the same key K_{ab}=K_{ba} which they can use to communicate securely. As an example, ƒ(K,M) can be an encryption algorithm E_{K}(M). The center generates

$$( \begin{matrix}n \\ 2\end{matrix} )$$

keys and allocates one key to each pair of devices. The center generates the matrix M by calculating the matrix elements as M_{i,j}=E_{Kp}_{ᵢ}(K_{i,j}), where

K_{i,j} is the key allocated to the pair of devices I and J.

Kpᵢ is the public information of the device I.

Mᵢ is the element at the line i, in the column j (column that is sent to device J and that constitutes the secret information of this device).

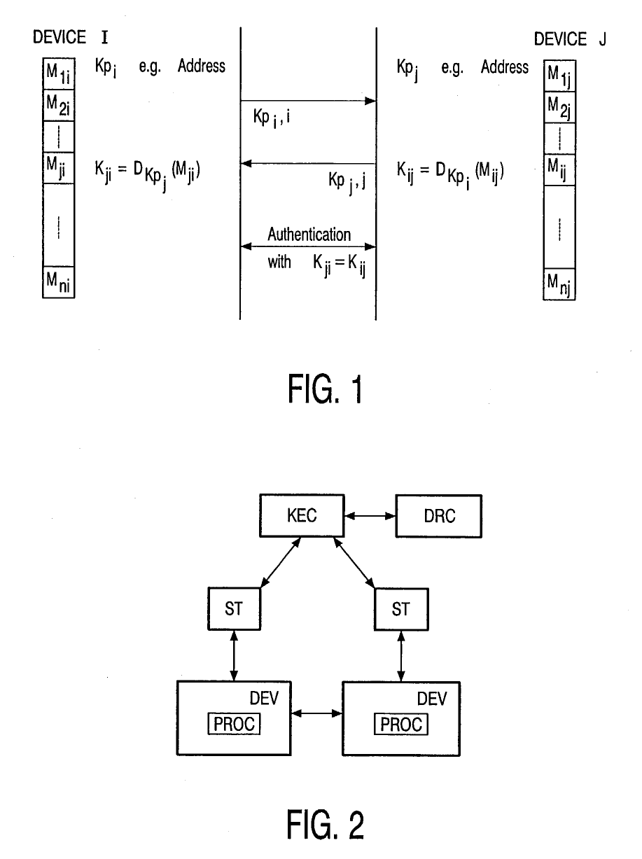

FIG. 1 illustrates how this algorithm is used during the communication between the devices. Each device sends its public information Kₚ_{ᵢ} (e.g. an address) and its column number i to the other device. Using this information as a key to decrypt the element in its column corresponding to the other device, each device obtains the same secret key that they use to authenticate each other. Any suitable authentication scheme may be used. As an example, in a challenge-response way device I can generate a random number, encrypt it with its key Kⱼᵢ, send the encryption result to J, which decrypts it with its key Kᵢⱼ, and sends the plain form of the random number back. If this matches the original random number, this is an indication that J is authentic.

It will be appreciated that columns and rows can be interchanged without changing the principle. Moreover, instead of associating a device with a column of keys (i.e. mere data used by an algorithm) where each key in turn is associated with a respective one of the devices with which it can communicate, the device can also be thought of as being associated with a set of algorithms, where each of these algorithms is associated with a respective one of the devices with which it can communicate. Those algorithms may be functionally unique, but may also be functionally the same but made to behave distinctly by incorporating a unique key. As such, ‘data’ and ‘algorithm’ can be interchanged as will be appreciated by persons skilled in the art.

A problem with both the basic and complex form of the KPS system is that it is not practical for use in large systems, where the number of devices (expressed by n) is large (e.g ranging from several thousand to even hundreds of millions of devices). The amount of information which needs to be transmitted securely and that each device must store securely is not feasible. This is particularly true for CE devices, like telephones, which must be very low-cost and which are sold in high quantities.

It is an object of the invention to provide a method, system and central for generating a common key that is suited for use in systems with a large number of devices, while and that is cost-effective. It is also an object to provide a method and device for using the common key.

To meet the object of the invention, the system for generating a common encryption key for secure communication between devices includes:

a plurality of devices, each associated with at least one unique device identifier; the plurality of devices being arranged in subgroups Sᵢ(i=1 . . . n) of devices, with at least one of the subgroups including a plurality of devices; and

a central device including an algorithm generator for generating a key generating algorithm KGAᵢ for each of the plurality of devices based on its associated unique device identifier; each of the key generating algorithms KGAᵢ being unique for a respective associated subgroup Sᵢ with the key generating algorithms KGAᵢ being the same for each device of the same subgroup Sᵢ; for each subgroup Sᵢ the associated key generating algorithm KGAᵢ being operative to generate for devices of each subgroup Sⱼ a common subgroup key SGK_{i,j} for use in communication between a device of subgroup Sᵢ and a device of subgroup Sⱼ; the common subgroup key SGK_{i,j} being generated in response to receiving any one of the device identifiers associated with a device in the subgroup Sⱼ;

each device being associated with a respective storage for storing its associated key generating algorithm and including a processor for executing the associated key generating algorithm.

By grouping devices in subgroups the number of common keys is reduced. The key generating algorithm only needs to be able to generate a unique key for each pair of subgroups instead of for each pair of devices. By still using the device identifiers as input to the algorithms, the publicly exchanged information hides the underlying subgrouping to malicious users.

As described in the dependent claims 2 and 3, preferably the device ID is reduced in number of bits, by hashing the device ID. The reduced number of bits can be seen as a subgroup identifier used for generating the common subgroup key. Hashing algorithms are generally known. Any suitable hashing algorithm may be used.

As described in the dependent claim 4, the subgroups are associated with predetermined functionality. For a simple system used for CE applications, the subdivision in different subgroups may start with a division between control (could be the device with a central role within the domestic piconet), source, rendering, processing, or copying devices. Preferably, more than five subgroups are created. This can, for instance, be achieved by further distinguishing between audio or video devices, giving ten subgroups in this example. A further distinction can be made between the types of audio/video data, like audio in the form of a PCM file or MP3 or ATRAC or AAC . . . , video in the form of a MPEG file or MPEG2. In this way, many subgroups can be created. Each subgroup leads to more different common keys, and as such increases the security of the system at higher cost, for instance caused by an increase in storage requirements. A person skilled in the art will be able to make an optimal choice for a system in question.

As described in the dependent claim 7, the device determines the functionality of a further device from the subgroup identifier of that device and communicates with that device according to that functionality. For instance, a source device may allow certain digital content to be sent to a rendering device but may refuse it being sent to a copying device. As a further example, a source device may allow reproduction by only one rendering device at a time.

As described in the dependent claims 8 and 9, the key generating algorithm KGAᵢ associated with subgroup Sᵢ includes a set SGEDRᵢ of representations of common subgroup keys that includes for each subgroup Sⱼ a representation of a respective unique common subgroup key SGK_{i,j}. These representation may simply form a column of keys. The keys may be in plaintext form. This is a storage-effective way of achieving that the key generating algorithm produces a different output for each subgroup Sⱼ by being fed by different keys.

As described in the dependent 10, and 11, security is increased by mixing the device identifier with secret information and using the outcome to encrypt the common subgroup keys.

As described in the dependent claim 12, the subgroups are grouped into groups, allowing the use of a more limited number of unique common keys for pairs of groups instead of unique common keys for each pair of subgroups. The groups are, preferably, also arranged according to functionality. As described in claim 13, the grouping can be advantageously used for broadcasting, allowing a broader range of devices to receive the protected information via the same communication channel. For instance, if a first group of devices is formed by source devices and a second group of devices is formed by rendering devices, a source device may allow all rendering devices to simultaneously receive the same protected content. It may, for instance, do this by fully authenticating each rendering device that wishes to establish a communication session. It may, at its choice, also limit the number of rendering devices by at a certain moment stopping the authentication (e.g. by not providing its device identifier to a second or third rendering device).

These and other aspects of the invention will be apparent from and elucidated with reference to the embodiments shown in the drawings.

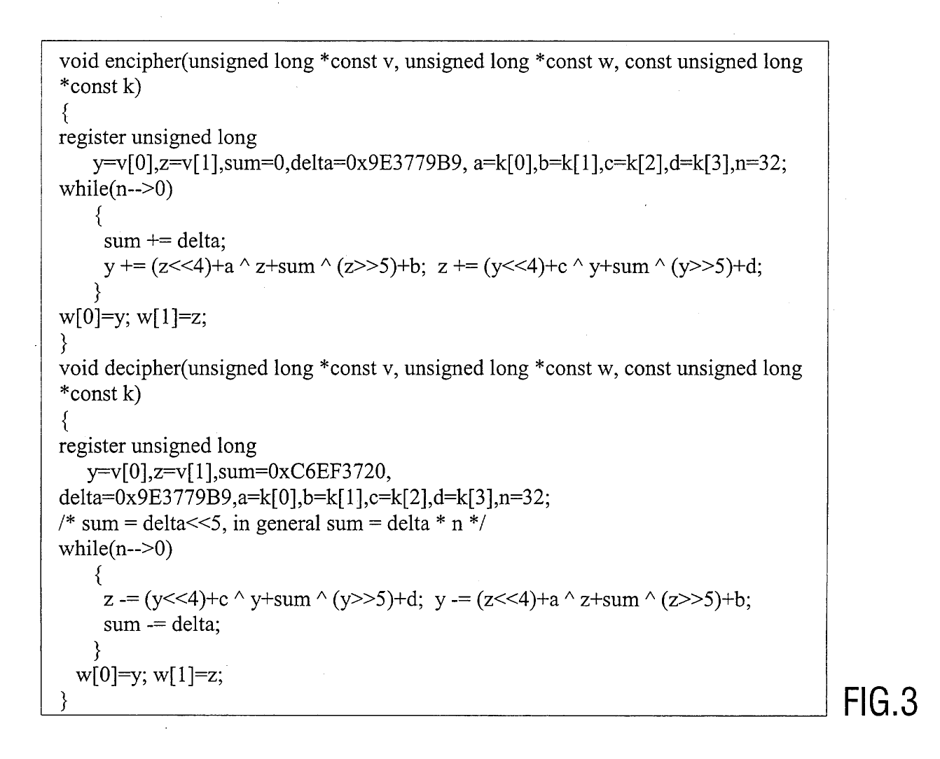

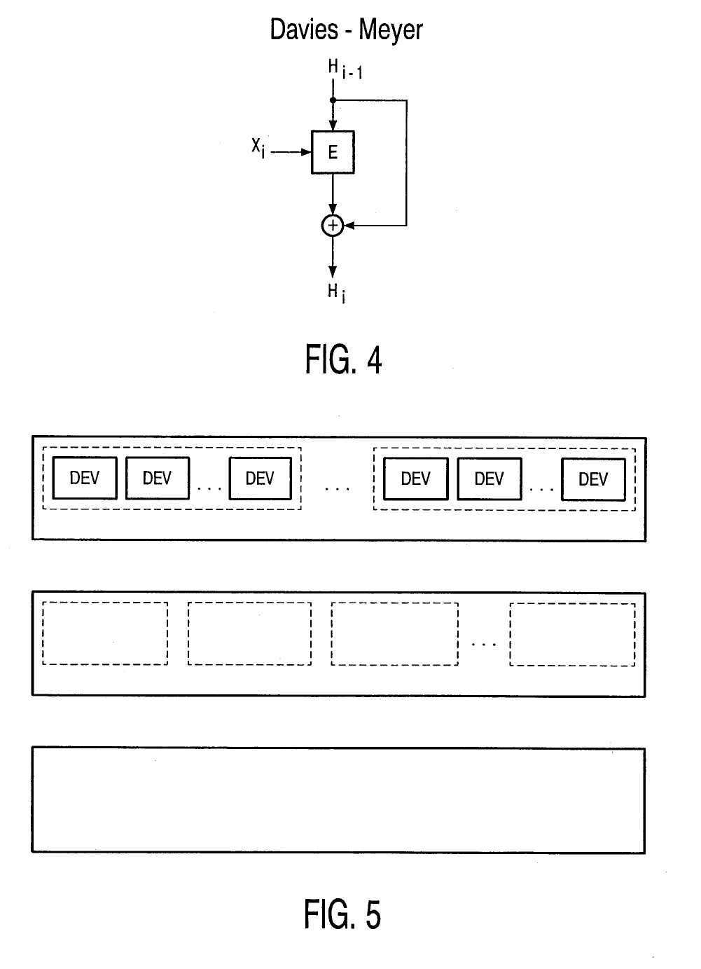

FIG. 1 shows a block diagram of the prior art KPS system, FIG. 2 shows a block diagram of a prior art key escrow system, FIG. 3 shows the source code for the prior art TEA block cipher, FIG. 4 shows the prior art Davies-Meyer scheme for using a block cipher as a hash function;

FIG. 5 illustrates the arrangement of devices in groups and subgroups according to the invention;

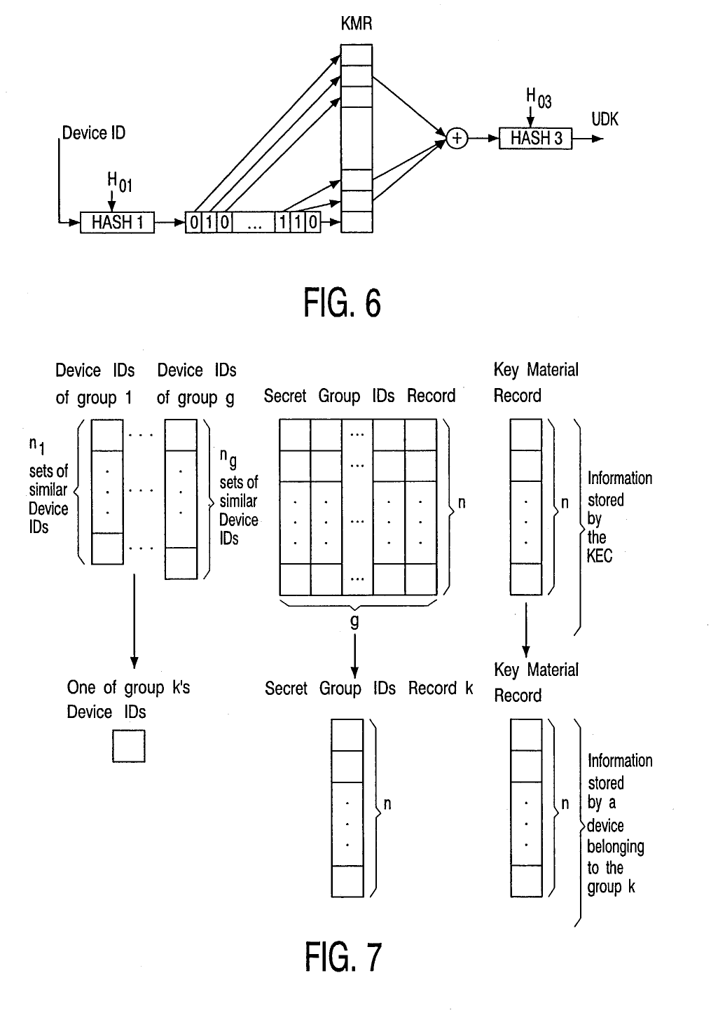

FIG. 6 shows an embodiment wherein the public Device ID is mixed with secret information;

FIG. 7 shows the overall allocation of key information between the KEC and the devices;

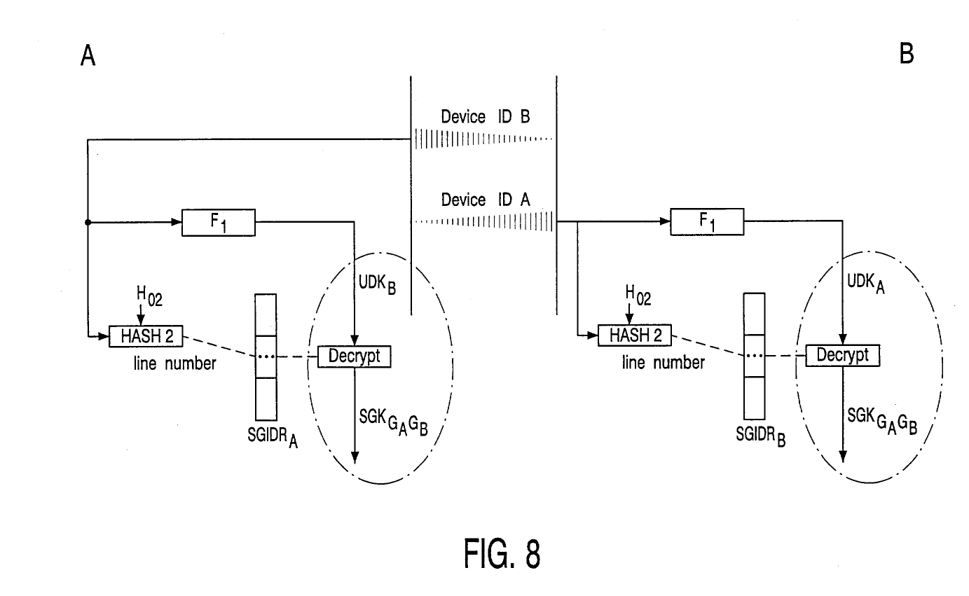

FIG. 8 shows details of generation of the common key in a device;

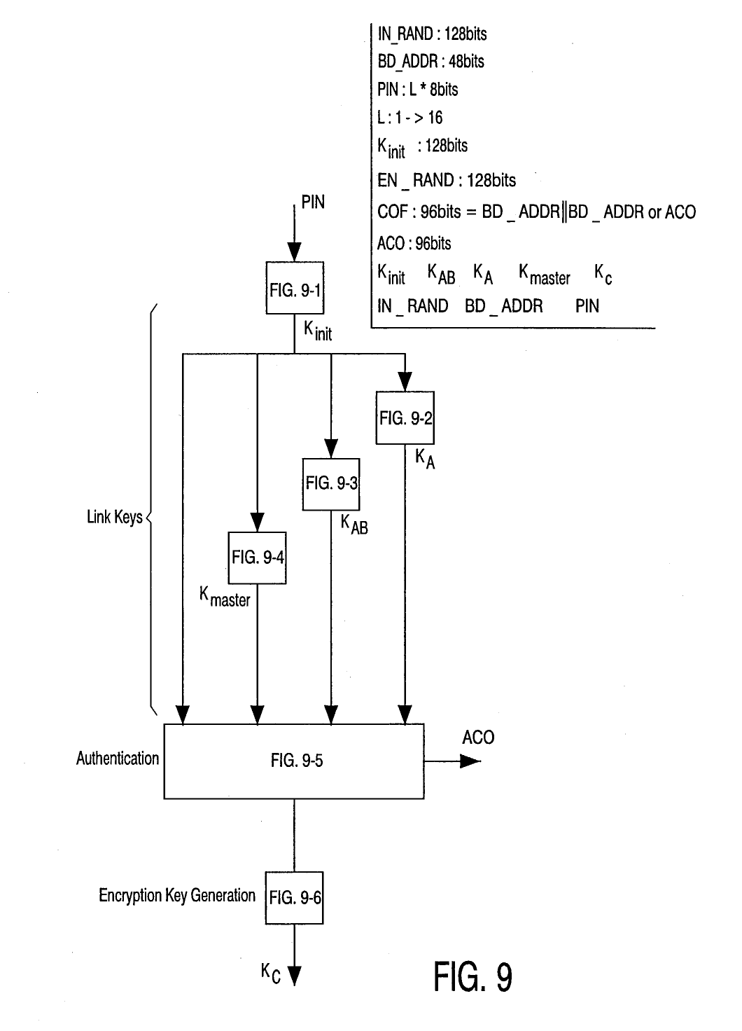

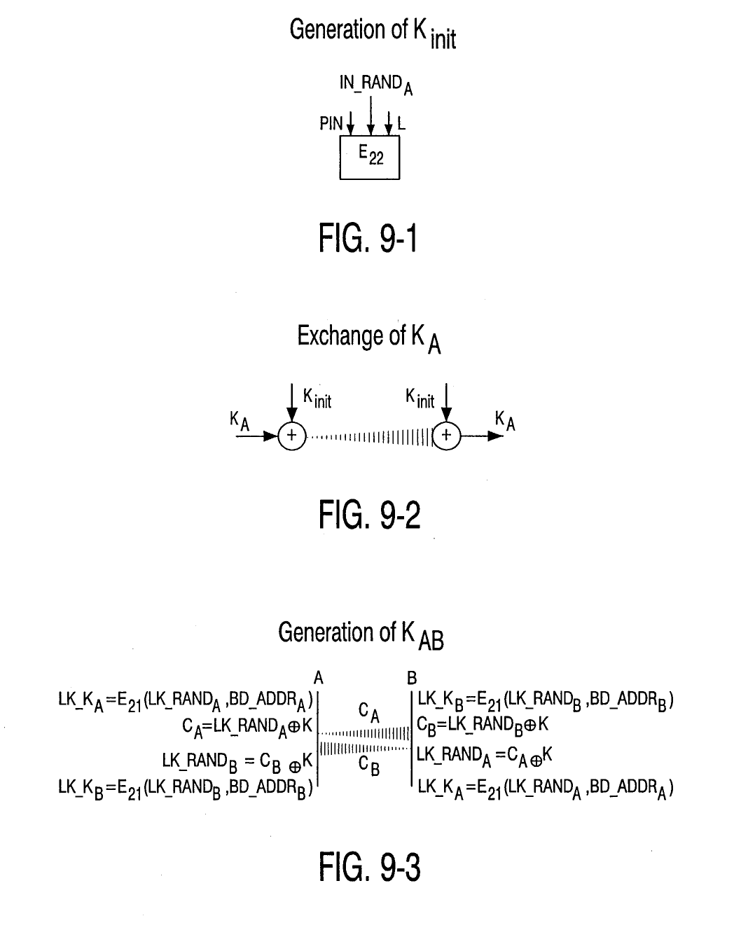

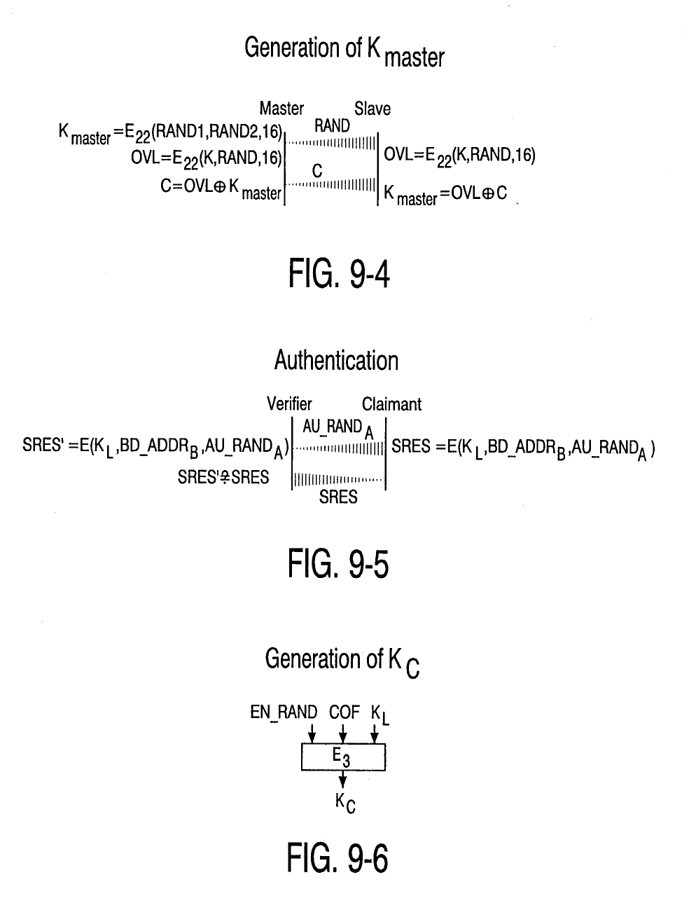

FIG. 9 shows the prior art link level Bluetooth protocols for authentication and key generation between Bluetooth devices; and

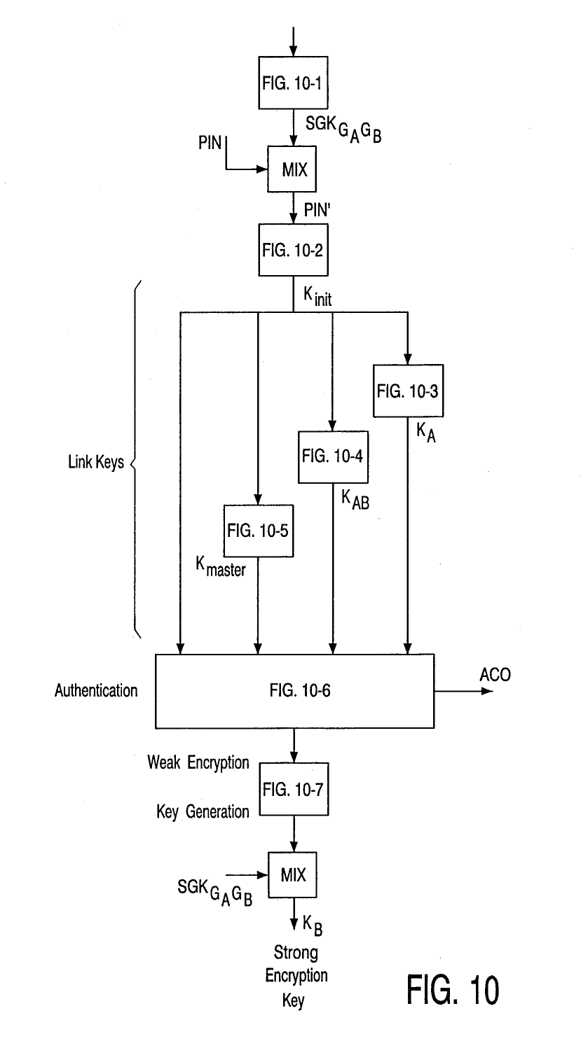

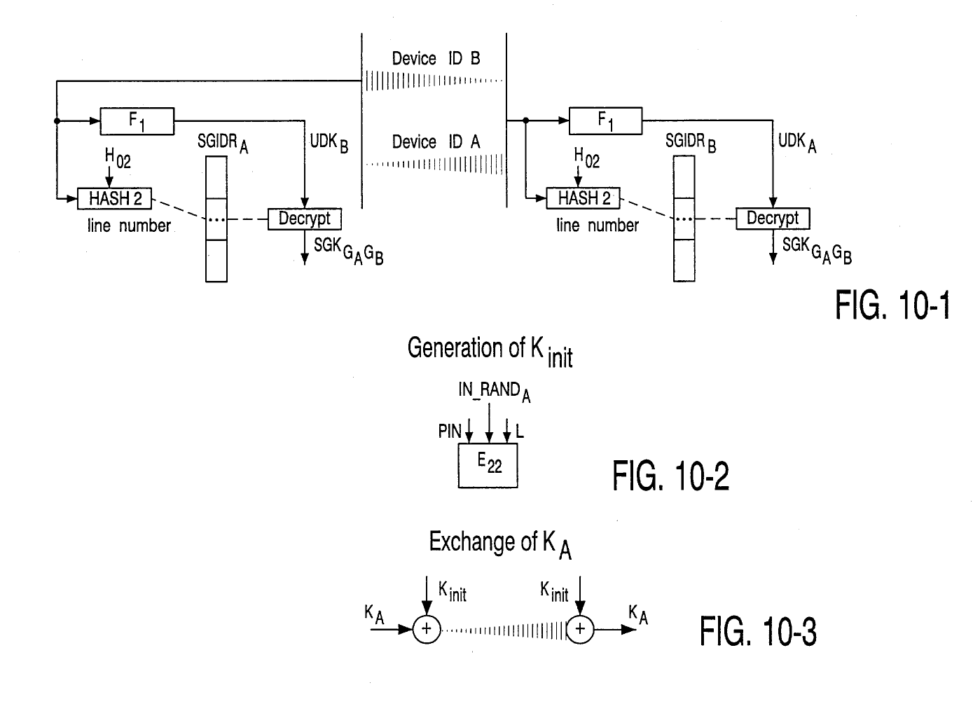

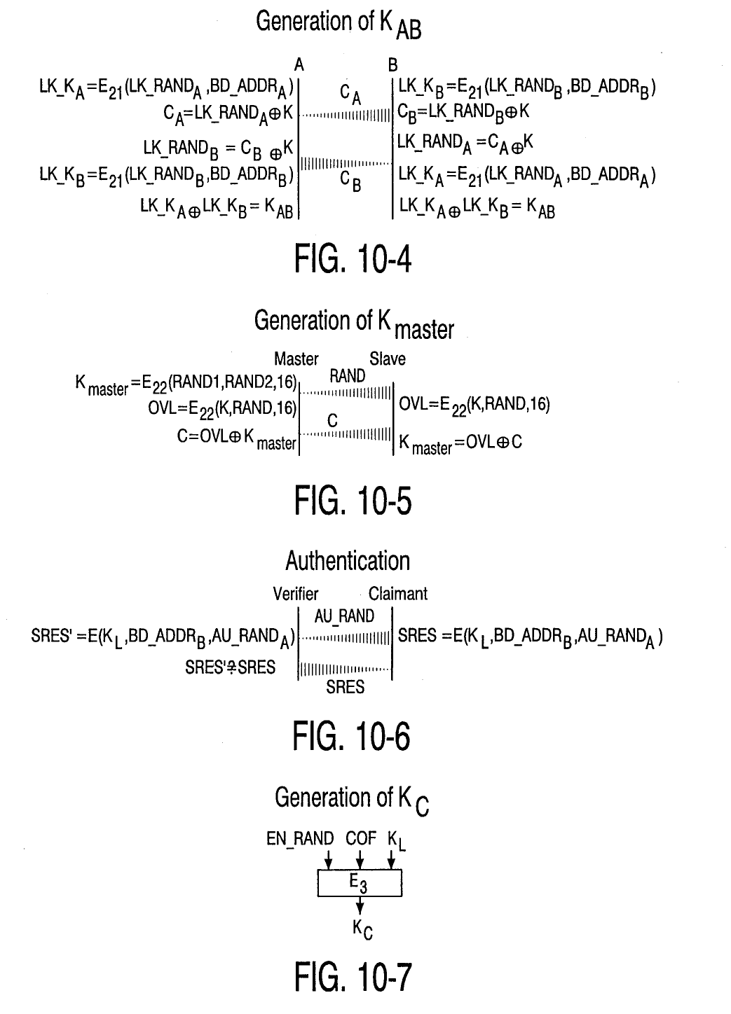

FIG. 10 shows adding application layer security according to the invention to the Bluetooth link layer security.

FIG. 2 shows a block diagram of a prior art key escrow system as also applies to the system according to the invention. Block 200 shows the Key Escrow Component (KEC). For simplicity, it can be regarded that this entity has the responsibility of stocking, releasing and managing the whole key material infrastructure. Block 210 shows the Data Recovery Component (DRC) which performs a specific authorized data recovery. Blocks 220 and 230 show respective User Security Component (USC), also referred to as device (DEV). Only two devices are shown, but it will be appreciated that the system according to the invention is optimal for systems with a possibly very large number of devices. It will be appreciated that with system is meant all components using the same common key scheme. In practice a user may only have a few end devices in a much smaller systems at his home. These devices could in principle also have been working in systems in other homes and as such can be seen as being part of one large system. The USC component is typically embedded in a CE device and executes all the encryption, decryption, and hash operations involved in the content protection system according to the invention. In principle, key escrow systems are known. The system according to the invention can be executed in the existing or future hardware platforms suitable for a key escrow system. In particular, the device may include a conventional processor or specialized cryptographic processor for executing the key generating algorithm according to the invention. The processor is usually operated under control of a suitable program product (firmware) to perform the steps of the algorithm according to the invention. This program is normally loaded from a background storage, such as a harddisk or ROM. The computer program product can be stored in the background storage after having been distributed on a storage medium, like a CD-ROM, a smart-card, or via a network, like the public Internet. Sensitive information, like the key generating algorithm is preferably transferred from the central device 200 to the associated device in a secure way. The figure shows using a secure storage 222 and 232, like a smartcard, card, for transferring the algorithm to the associated device. It is also possible that the central device has transferred relevant data for many algorithms to a manufacturer of the devices, where the manufacturer ensures that each device is provided with the algorithm associated with the device. Many ways of securely passing on such data and algorithms are know. Such mechanisms are not the subject of the invention.

Prior Art Cryptographic Functions

Hash Function

A hash function is a function that maps an input of arbitrary length into a fixed number of output bits. There are two types of hash functions. A MAC (Message Authentication Code) that uses a secret key, and an MDC (Manipulation Detection Code) that works without a key. In the following description the use of MACs is preferred, using sometimes the term hash for MAC. An important property of a MAC is that: “it should be impossible to compute the MAC without knowledge of the secret key”. It has not to be collision resistant (meaning that it is computationally possible to find two arguments hashing to the same result). This also means that it is very difficult if not impossible to compute the argument of the MAC from the MAC itself without the knowledge of the secret key. When placed within a cryptographic architecture, a MAC should be seen as a fence for people that don't have the secret key.

Block Cipher TEA

The Tiny Encryption Algorithm (TEA) is currently one of the fastest and most efficient cryptographic algorithms. Its latest versions are believed to be robust against known cryptanalysis. TEA takes as input a block of 64 bits, uses a key of 128 bits to produce a cipher of 64 bits. The algorithm itself requires a constant of 32 bits, a 32 bits variable to hold the current sum and two 32 bits intermediate variables. The TEA algorithm is described in source code. This code is shown in FIG. 3. It should be noted that the common key generating algorithm according to the invention does not rely on the use of a specific cipher. Any suitable cipher may be used.

Hash Based on a Cipher

A block ciphers, like TEA, can be used for encryption/decryption purposes but also as hash function. Various ways of achieving this are known. FIG. 4 shows the so-called Davies-Mayer scheme. It requires:

a generic n-bit block cipher E_{K} (for instance TEA) parameterized by a symmetric key K;

a fixed initial value IV, suitable for use with E.

The input is a bitstring x, the output an n-bit hash-code of x. The input x is divided into k-bit blocks xᵢ where k is the key size, and padded, if necessary, to complete the last block. Denote the padded message consisting of t k-bit blocks: x₁x₂ . . . xₜ. A constant n-bit initial value IV is pre-specified. The output is Hₜ is defined by:

H₀=IV;

Hᵢ=Eₓ(Hᵢ₋₁)\mathring{+}Hᵢ₋₁, 1<i<t.

Content Protection System

According to the invention, the system can incorporate a very large number of devices. As it is not possible to create different secret keys for each possible pair of devices, the devices are arranged in a plurality of disjunct subgroups Sᵢ of devices. Preferably, the devices within a same subgroup have the same or similar functionality (e.g. all same phones or all devices capable of rendering MP3 audio). With similar functionality is meant that means that such devices have the same behavior in the system, even if, for security reason, it is not visible from the user point of view. In a further embodiment, the subgroups are again arranged in groups. This higher level grouping is not required but opens further possibilities as will be elaborated below. For the remainder of the description it is assumed that both levels of grouping are used.

FIG. 5 illustrates the arrangement of devices in groups and subgroups according to the invention. Shown are groups 320, 321 and 322 of devices. Each of those groups includes at least one subgroup of devices. A subgroups falls entirely within a group (so a subgroup does not fall into two or more groups). At least one of the groups includes at least two subgroups. Shown are the subgroups 301, 302, 303, 304, and 305. Each subgroup includes at least one device. A device is a member of only one subgroup for one set of functionality. It may be desired that a multi-function device is part of several subgroups. This can simply be achieved by letting the device have multiple device identifiers. In this sense, such a multi-function device is regarded as several devices.

Each device receives a different public key, called a Device ID. This may be the same (but does not need to be the same) as the device uses for identification (e.g. device address) in the communication with another device. As will be described in more detail below, devices with similar functionality (i.e. in the same subgroup) still receive unique Device IDs, however those IDs have been generated/selected such that they result in the same behavior according to the described algorithm.

Instead of having a different secret key for each possible pair of devices, there is a different secret key for each pair of subgroups or groups, including reflections. This secret key is called the Secret Group Key SGK_{G}_{ₐ}^{,G}_{_{b}} for each respective pair of groups Gₐ and G_{b} or Secret SubGroup Key SGK_{i,j} for each respective pair of subgroups Sᵢ and Sⱼ. The description will focus on using group keys.

For an advanced embodiment of the system, preferably, the following functions are used:

3 hash functions HASH1, HASH2, HASH3 using H₀₁, H₀₂, H₀₃ as secret keys.

The operation shown in FIG. 6, called extraction of UDK (Unique Device Key). Starting from HASH1(Device ID), the bits set to 1 in the output of this hash function are used to select elements in a vector (called Key Material Record, see below for the meaning of the name). The selected elements are XORed together indicated by \mathring{+}. The result is hashed using HASH3. In the following description, this entire function starting with HASH1 to and including HASH3 will be referred to as F₁( ). The purpose of F₁ is to ensure that public key Device ID is not directly used in the algorithm but is mixed with secret information unique for the device. The HASH3 functions to protect exposing elements of the Key Material Record. HASH1 functions to match the size of the device ID to the number of elements in the Key Material Record. As such any length of Key Material Record can be used. It will be appreciated any suitable mixing algorithm may be used. If no high level of security is required also the Device ID can be directly used.

Construction of the System

Steps of construction:

All devices in the entire system are divided into g different groups Gₖ, k going from 1 to g (example of groups: recording devices, rendering devices, processing devices, . . . ).

The KEC generates

$$\frac{g ( g + 1 )}{2}$$

random Secret Group Keys (SGK). The Secret Group Keys are the keys that will be recovered at the end of the protocol and that will enable the content protected communication between two devices. There is such a SGK for each groups pair including reflections.

The KEC generates and provides to all devices a Key Material Record (KMR) as a list of random numbers. As described earlier, use of the mixing based on the KMR is optional.

For each group Gₖ, the KEC generates nₖ sets (also referred to as subgroups) of similar

$$Device IDs ( {\sum }_{k = 1}^{g} {n}_{k} = n )$$

each set including at least one Device ID, and distributes the respective Device IDs to the associated device belonging to this group. Those Device IDs are random numbers and constitute the only public information. The Device IDs are generated such that:

For Device IDs belonging to different sets of similar Device IDs:

The last m bits of HASH2(Device ID) are different (with 2^{m}>n and 2^{m-1}<n). It will be appreciated that instead of using the last m bits also m other bits can be selected in a predetermined way. Note that randomly generating n numbers with last m bits different requires the generation of

$${\sum }_{i = 0}^{n - 1} \frac{m}{m - i}$$

numbers. To give an example, 304 numbers will be required to generate 64 (2⁶) numbers satisfying the condition and 168449 numbers to generate 16382 (2¹⁴) numbers satisfying the same condition.

* The numbers (called Unique Device Key(UDK) of this Device ID) equal to F₁(Device ID) are different. As indicated before, use of F₁ is optional. If F₁ is not used, UDK equals the Device ID and as such is automatically unique.

For Device IDs belonging to the same set of similar Device IDs,

The last (or any predetermined position of) m bits of HASH2(Device ID) are identical (with 2^{m}>n and 2^{m-}1<n)

The number (called Unique Device Key(UDK) of this Device ID) equal to F₁(Device ID) are identical. As described above, the use of F₁ is optional.

For each group Gₗ, the KEC generates and sends to each device belonging to this group a Secret Group ID Record (SGIDR^{l}) in the form of a column of n numbers generated such that: for each set of similar Device IDs and considering only one Device ID in each set,

m being equal to the number formed from the last significant bits in HASH2(Device ID),

Unique Device Keyₘ being equal to F₁(Device ID)

Secret Group Key_{G}_{ₗ}^{G}_{ₘ} being the Secret Group Key used for the communication between devices belonging to the group Gₗand devices belonging to the group Gₘ

SGIDR^{ml}, the element at row m in the Secret Group ID Record of group Gₗ is equal to E(Unique Device Keyₘ, Secret Group Key_{G}_{ₗ}^{G}_{ₘ}).

As illustrated in FIG. 7, eventually, a device belonging to the group Gₖ contains:

one of the Device ID of the group Gₖ,

the Secret Group IDs Record of the group Gₖ(SGIDRₖ), and

optionally, the Key Material Record (KMR).

The KEC stocks all the Device IDs, the g Secret Group IDs Records and the Key Material Record.

FIG. 8 shows details of generation of the common key in a device. Each device optionally calculates F₁(Device ID) of the other device's Device ID, the result is the Unique Device Key(UDK) of the other device. Each device also hashes (HASH2) the other device's Device ID and uses the m least significant bits of the result as a line number in the Secret Group IDs Record(SGIDR). The HASH2 function operates to reduce the number of bits in the public device ID to only m bits where the system supports up to 2^{m} subgroups. The Secret Group ID Record contains an element for each subgroup. In principle, these elements may be stored in plaintext form. To increase security, it is preferred that these elements are stored in an encrypted form. As shown, in device A the element that corresponds to device B is has been encrypted by the KEC under control of the UDK corresponding to the Device ID of B. Therefore, device A decrypts this element under control of the same UDK. In this way device A retrieves SGK_{G}_{_{A}}^{G}_{_{B}} which is the Secret Group Key that devices of the same group than the device A (group G_{A}) use to communicate with devices of the same group than B (group G_{B}). In the described preferred embodiment, the UDK is the same for devices of the same subgroup. Moreover, the elements in the Secret Group ID Record, although they correspond to respective subgroups, are in fact representative of the group of the subgroup. So, in a system with four groups of each three subgroups, the Secret Group ID Record contains a 12 elements, since there are twelve subgroups. These 12 elements represent in fact only four common group keys (three representations for each group). Each of the three representations for the same group are the result of encrypting the common group key with respective UDKs for the three subgroups within the group, giving three different elements in the Secret Group ID Record. Consequently, the record includes 12 different elements. It will be clear that if a subdivision at group level is not required, then instead of representing the four common group keys in the record, simply twelve common subgroup keys could have been placed in the record.

Note that in the system according to the invention no line number is transmitted unlike the known PKS system. This increases the security, since the position in the record is not known to malicious users.

Bluetooth

Content protection is, for instance, used when data is digitally transferred from a sending device to a receiving device to ensure that only an authorized receiving device is able to process or render the content. The Bluetooth technology provides peer-to-peer communication over a relatively short distance of approximately ten meters. The system provides security measures both at the application layer and at the link layer. The link layer security measures are described in Chapter 14 “Bluetooth Security” of section “Baseband Specification” of the Bluetooth Specification Version 1.0A of Jul. 24, 1999. This chapter describes the way in which authentication takes place between Bluetooth devices and the generation of keys which can be used for encryption/decryption purposes. Four different entities are used for maintaining security at the link layer: a public address which is unique for each user (the 48-bit IEEE Bluetooth device address, BD_ADDR), a private user key for authentication, a private user key for encryption and a random number (RAND) of 128 bits. The encryption key can be used for content protection. The random number is different for each new transaction. The private keys are derived during initialization and are further never disclosed. Normally, the encryption key is derived from the authentication key during the authentication process. For the authentication algorithm, the size of the key used is always 128 bits. For the encryption algorithm, the key size may vary between 1 and 16 octets (8 -128 bits). The size of the encryption key is configurable, among others to meet the many different requirements imposed on cryptographic algorithms in different countries-both with respect to export regulations and authority attitudes towards privacy in general. The encryption key is entirely different from the authentication key (even though the latter is used when creating the former). Each time encryption is activated, a new encryption key shall be generated. Thus, the lifetime of the encryption key does not necessarily correspond to the lifetime of the authentication key. It is anticipated that the authentication key will be more static to its nature than the encryption key—once established the particular application running on the Bluetooth device decides when, or if, to change it. To underline the fundamental importance of the authentication key to a specific Bluetooth link, it will often be referred to as link key. The RAND is a random number which can be derived from a random or pseudo-random process in the Bluetooth unit. This is not a static parameter, it will change frequently. FIG. 9 shows the current Bluetooth protocols for authentication and key generation between Bluetooth devices at the link layer.

The described Bluetooth security mechanism has the following problems:

The PIN number may be chosen by the user. It is in the interest of a user to ensure that no unauthorised person can use his Bluetooth device(s). As such, a user may be expected to use the Bluetooth system as intended for purposes which, for instance, involve privacy. However, if the system is used to exchange digital content for which the user has to pay, the user may be tempted to try and break the security. By changing the PIN number, a malicious user is able to retrieve all the link keys and the encryption key. This means that the user is able to intercept and decrypt encrypted content or authenticate non-compliant devices.

The encryption key is of variable size depending on the country where the device is used. In some countries, this size may be of 8 bits. An exhaustive search of those encryption key will then only require 256 (2⁸) attempts. Allowing such a low level of security to be used could result in digital content being easily obtained in one country and then illegally being distributed to other countries.

It is therefore preferred that at the application layer a Content Protection System is used that provides protection of the content against infringers including a malicious user.

FIG. 10 shows how the application layer security according to the invention can be described as an augmented version of the Bluetooth link layer security. This improves Bluetooth's security so that it can be used for exchange of digital content. The Secret Group Key SGK_{G}_{_{A}}^{G}_{_{B}} is inserted at the very beginning and before encryption. The protocol takes place before devices establish the communication for the very first time. The result, SGK_{G}_{_{A}}^{G}_{_{B}}is mixed with the PIN code (the mixing function may be a simple bitwise XOR operation, however it is preferred to encrypt the PIN code with SGK_{G}_{_{A}}^{G}_{_{B}}) to provide:

a mechanism robust against malicious user for authentication, in which devices can proof to each other that they are certified as being compliant.

an additional level of robustness (tunable via the choice of the mixing function) to the privacy protection.

If the first goal is not required, then the key should only be used for the second step. After that, the SGK_{G}_{_{A}}^{G}_{_{B}} is mixed with the Encryption Key (the mixing function may be again be a simple bitwise XOR operation, or based on encrypting the code with SGK_{G}_{_{A}}^{G}_{_{B}}) to afford:

a robust content protection.

a mechanism to allow escrow of private communications in countries where this is a legal requirement.

In the countries where the encryption key is very little, it may be possible for a malicious user to retrieve SGK_{G}_{_{A}}^{G}_{_{B}}, especially if the result of the last XOR is used to encrypt the whole communication. To prevent this, the key from the last XOR (strong encryption key) might be used to establish, exchange and update a new key that will be used for the rest of the communication.

Point-To-Multipoint Communication (Broadcasting or Multicasting)

So far the description has focussed on communication between two devices. An advantage of the proposed system, compared to the complex KPS is that it can make it easier for a master device to communicate with several slave devices. When considering a master device belonging to the group G_{K} (e.g. the group of processing devices like Set Top Boxes) and m slave devices of the same group G_{L} (e.g. the group of rendering devices like headphones), the proposed system facilitates the point-to-multipoint communication between the master and the slave devices. Indeed, as a Secret Group Key is attached to a certain pair of groups, a content protected communication between the master device and the slave devices is possible just by using the same Secret Group Key SGK_{KL}.

In the Bluetooth protocol at the link layer, point-to-multipoint communication is possible thanks to the generation of a master key (see FIG. 9). The master key is generated by the master from two random numbers and a cryptographic function E₂₂. Then, repeating the same exchanges of messages as described in FIG. 9 (see function E₂₂) with each slaves, the master securely communicates the master key to the slaves. In the Bluetooth protocol with content protection at the application layer, because the slave devices belong to the same group, when initiating the communication with the master device, the Secret Group Keys generated during the Content Protection protocol (see FIG. 10) will always be the same. From that point, the master device generates the master key, securely transmit it with the slave devices and the point-to-multipoint communication can take place.

DRC: Key Recovery

In countries where key escrow is a legal requirement, the authorized authorities receive a special device, containing the DRC. In order for the DRC to be able to retrieve the plaintext from the ciphertext, the KEC sends to the DRC the Key Material Record, the Secret Group IDs Records, the constants used in the hash functions and the repartition of the Device IDs between the groups. Then, when a communication occurs, the DRC is able to select the correct key SGK_{AB} from the device IDs and is able, in the countries where this is a legal requirement, to retrieve the strong encryption key using a brute force attack on the weak encryption key.

Flexibility

The presented protocol does not prescribe using specific algorithms for the basic functions, like encryption, decryption, authentication, and hashing. Even the optional function F₁ may be replaced by any other one-way function. All lengths in bits of the elements in the UDK, SGIDR, SGK and the length of the output of HASH3 can be tailored to the chosen algorithms. It is also not prescribed how many groups, subgroups or Device Ids there are. Of course, the more subgroups there are, the more secure the protocol will be. Two devices from the same set of similar devices can share the same Device ID. Note that a device can have more than one functionality. In those cases, there is a connection for each application/functionality.

Dimensions of the Records

Concerning the Key Material Record, its size should be at least enough to provide a different Unique Device Key to each Device ID. In theory, if there are n elements in the record, then there must be

$${\sum }_{i = 1}^{n} ( \begin{matrix}n \\ i\end{matrix} )$$

different possible outputs of the XOR, but in practice, the size should be as big as possible in order to make it easier to generate Device IDs with different output of F₁. Each Secret Group ID Record must contain as many elements as there are sets of similar Device IDs. It is also possible to make bigger records in order to complicate the task of attackers.

Updating

It is preferred to be able to update the secret information contained in a device whenever those secrets are publicly known. The proposed solution relies on shared secrets and is by nature of a limited security. Changing the secrets is a good way to-reinitialize the security of the system. Secrets that could be updateable are:

The constants used for the hash functions.

The Secret Group IDs

The Key Material Records

The Unique Device Key

The Secret Group Keys

Note that modifying those secrets automatically requires changing the Device IDs.

Device Revocation

In addition to the updatability of the secrets, it is preferred to be able to revoke devices. Three kinds of revocations may be distinguished:

Revocation of a group of devices: may be done by e.g. modifying one of the hash's initial constant in all the devices belonging to this group or, by modification of all the devices, by invalidating all the elements in the Secret Group IDs Records containing the Secret Group Key that allow each specific device to communicate with this specific group of devices.

Revocation of a set of similar devices: may be done by e.g. modifying one of the hash's initial constant in all the devices belonging to this set of similar devices or by modification of the element in the Secret Group IDs Records that allow each specific device to communicate to a device of this specific set of similar devices.

Revocation of a specific device: in a system where several devices can share the same Device ID and because of the existence of similar devices having a Device ID with the same behavior in the system, that revocation can only be done by the device itself, by the modification of e.g. the hash's initial constant.

When a device is revoked, the authentication following the additional protocol will fail.

1. A system for generating a common encryption key for secure communication between devices; the system including:
a plurality of devices, each associated with at least one unique device identifier; the plurality of devices being arranged in subgroups Sᵢ(i=1 . . . n) of devices, with at least one of the subgroups including a plurality of devices; and
a central device including an algorithm generator for generating a key generating algorithm KGAᵢ for each of the plurality of devices based on its associated unique device identifier; each of the key generating algorithms KGAᵢ being unique for a respective associated subgroup Sᵢ with the key generating algorithms KGAᵢ being the same for each device of the same subgroup Sᵢ; for each subgroup Sᵢ the associated key generating algorithm KGAᵢ being operative to generate for devices of each subgroup Sⱼ a common subgroup key SGK_{i,j} for use in communication between a device of subgroup Sᵢ and a device, of subgroup Sⱼ; the common subgroup key SGK_{i,j} being generated in response to receiving any one of the device identifiers associated with a device in the subgroup Sⱼ;
each device being associated with a respective storage for storing its associated key generating algorithm and including a processor for executing the associated key generating algorithm.

2. A system as claimed in claim 1, wherein the algorithm generator is operative to hash a unique device identifier to a subgroup identifier associated with a respective one of the subgroups and generating the key generating algorithm in dependence on the subgroup identifier.

3. A system as claimed in claim 1, wherein the key generating algorithm is operative to hash a unique device identifier to a subgroup identifier associated with a respective one of the subgroups and generating the common key in dependence on the

4. A system as claimed in claim 1, wherein at least one of the subgroups of devices is associated with predetermined functionality.

5. A system as claimed in claim 4, wherein at least devices having a respective recording, rendering or processing functionality are arranged in respective subgroups.

6. A system as claimed in claim 5, wherein a device associated with at least two respective functionalities is associated with at least two respective unique identifiers, each corresponding to a respective subgroup.

7. A system as claimed in claim 4, wherein a device is operative to, in response to receiving a device identifier from a further device in the system, is operative to hash the device identifier to a subgroup identifier associated with a respective one of the subgroups; to determine the functionality of the further device in dependence on the subgroup identifier and to communicate with the further device in dependence on the determined functionality.

8. A system as claimed in claim 1, wherein the algorithm generator is operative to (pseudo-)randomly generate a common subgroup key SGK_{i,j} for each respective pair of subgroups Sᵢ and Sⱼ; the key generating algorithm KGAᵢ associated with devices of subgroup Sᵢ including a set SGIDRᵢ of representations of common subgroup keys that includes for each subgroup Sⱼ a representation of a respective unique common subgroup key SGK_{i,j}.

9. A system as claimed in claim 8, wherein for each subgroup Sᵢ the associated key generating algorithm KGAᵢ is operative to generate the common subgroup key SGK_{i,j} for use in communication to a device in the subgroup Sⱼ by selecting a representation of the common subgroup key SGK_{i,j} from the set SGIDRᵢ of representations of common subgroup keys included in the algorithm.

10. A system as claimed in claim 8, wherein for each i and j the algorithm generator is operative to mix a device identifier of a device associated with the subgroup Sⱼ with secret information associated with the subgroup Sᵢ and to use the mixing output as a key for encrypting the common subgroup key SGK_{i,j} and using the encryption outcome as the representation of the common group key SGK_{i,j}.

11. A system as claimed in claim 10, wherein the key generating algorithm KGAᵢ associated with subgroup Sᵢ is operative to mix a device identifier of a device associated with subgroup Sⱼ with secret information associated with the subgroup Sᵢ and to use the mixing output as a key for decrypting the representation of the common subgroup key SGK_{i,j}.

12. A system as claimed in claim 1, wherein the subgroups of devices are arranged in groups; each group including at least one of the subgroups and at least one group including a plurality of subgroups; each respective pair of groups Gₐ and G_{b} being associated with a unique common group key SGK_{G}_{ₐ}^{,G}_{b} which is identical to the common subgroup key SGK_{i,j} for all subgroups Sᵢ of group Gₐ and all subgroups Sⱼ of group G_{b}.

13. A system as claimed in claim 12, wherein a device of a subgroup Sᵢ of group Gₐ is operative to use the same common group key SGK_{G}_{ₐ}^{,G}_{_{b}} for broadcast or multicast communication to a plurality of devices of at least one subgroup Sⱼ of group G_{b}.

14. A central device for use in a system for generating a key generating algorithm for secure communication between devices, each of a plurality of devices being associated with at least one unique device identifier; the plurality of devices being arranged in subgroups Sᵢ(i=1 . . . n) of devices, with at least one of the subgroups including a plurality of devices; the central device including an algorithm generator for generating a key generating algorithm KGAᵢ for each of the plurality of devices based on its associated unique device identifier; each of the key generating algorithms KGAᵢ being unique for a respective associated subgroup Sᵢ with the key generating algorithms KGAᵢ being the same for each device of the same subgroup Sᵢ; for each subgroup Sᵢ the associated key generating algorithm KGAᵢ being operative to generate for devices of each subgroup Sⱼ a common subgroup key SGK_{i,j} for use in communication between a device of subgroup Sᵢ and a device of subgroup Sⱼ; the common subgroup key SGK_{i,j} being generated in response to receiving any one of the device identifiers associated with a device in the subgroup Sⱼ.

15. A device for securely communicating to another device using a common encryption key; the device being associated with at least one unique device identifier and being a member of one of a plurality of subgroups Sᵢ(i=1 . . . n) of devices, with at least one of the subgroups including a plurality of devices; the device being associated with a respective storage for storing an associated key generating algorithm and including a processor for executing the associated key generating algorithm; the key generating algorithms KGAi being unique for the associated subgroup Sᵢ with the key generating algorithms KGAi being the same for each device of the same subgroup Sᵢ; the key generating algorithm KGAi being operative to generate for devices of each subgroup Sⱼ a common subgroup key SG_{i,j} for use in communication with a device of subgroup Sⱼ; the common subgroup key SGK_{i,j} being generated in response to receiving any one of the device identifiers associated with a device in the subgroup Sⱼ.

16. A method for generating a key generating algorithm for secure communication between devices in a system, where the system includes a plurality of devices, each associated with at least one unique device identifier; the plurality of devices being arranged in subgroups Sᵢ(i=1 . . . n) of devices, with at least one of the subgroups including a plurality of devices; the method including generating a key generating algorithm KGAi for each of the plurality of devices based on its associated unique device identifier; each of the key generating algorithms KGAi being unique for a respective associated subgroup Sᵢ with the key generating algorithms KGAi being the same for each device of the same subgroup Sᵢ; for each subgroup Sᵢ the associated key generating algorithm KGA_{i,j} being operative to generate for devices of each subgroup Sⱼ a common subgroup key SGK_{i,j} for use in communication between a device of subgroup Sᵢ and a device of subgroup Sⱼ; the common subgroup key SGK_{i,j} being generated in response to receiving any one of the device identifiers associated with a device in the subgroup Sⱼ.

17. A computer program product, wherein the program product is operative to perform the method of claim 16.

18. A method for generating a common encryption key for secure communication between devices; each of the devices being associated with at least one unique device identifier;- and each of the devices being a member of one of a plurality of subgroups Sᵢ(i=1 . . . n) of devices, with at least one of the subgroups including a plurality of devices; the method including using a key generating algorithm KGAi, which is unique for a subgroup Sᵢ with the key generating algorithms KGAi being the same for each device of the same subgroup Sᵢ, to generate for devices of each subgroup Sⱼ a common subgroup key SGK_{i,j} for use in communication between a device of subgroup Sᵢ and a device of subgroup Sⱼ; the common subgroup key SGK_{i,j} being generated in response to receiving any one of the device identifiers associated with a device in the subgroup Sᵢ.

19. A computer program product, wherein the program product is operative to perform the method of claim 18.
